(19) United States
(12) Patent Application Publication
(10) Pub. No.: US 2006/0271866 A1
(43) Pub. Date: Nov. 30, 2006

(54) Faceless parts within a parts-based user interface

(75) Inventors: Jeffrey Ryan Anderson, West Fargo, ND (US); Tristan Howard Cartony, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/139,252

(22) Filed: May 27, 2005

(51) Int. Cl. G06F 9/00

(52) U.S. Cl. 715/764

(57) ABSTRACT

A computer-implemented method supports a parts-based user interface. The method includes functionally establishing a part-to-part communication channel between a faceless part and a visible part. The communication channel is made by way of a standard communication interface through which the visible part is configured to communicate with other visible parts.

### BACKGROUND

The material in the following section is merely provided for general background information and is not intended to be used as an aid in determining the scope of the claimed subject matter.

Parts-based user interfaces are becoming increasingly common. In many cases, implementing this type of interface involves creation of individual parts that consume and/or provide data but generally have no knowledge of other parts. Various parts are then functionally linked together at runtime to support a cohesive user interface with multiple parts interacting with each other.

A parts-based user interface in a rich-client environment can require highly interactive communication between parts, as users expect the interface to be very dynamic. However, it is possible that a given functionality may not necessarily need to be visibly exposed. In many known systems, for a functionality that need not visibly expose a standard user interface component, implementation is supported only through a creation of customized communication channels.

### SUMMARY

This summary is provided to introduce in a simplified form some concepts, which are described below in the Detailed Description. This Summary is not intended to identify key features or essential features of the claimed subject matter, nor is it intended to be used as an aid in determining the scope of the claimed subject matter.

In one embodiment, a computer-implemented method is provided in support of a parts-based user interface. The method includes functionally establishing a part-to-part communication channel between a faceless part and a visible part. The communication channel is made by way of a standard communication interface through which the visible part is configured to communicate with other visible parts.

### BRIEF DESCRIPTION OF THE DRAWINGS

FIG. 1 is a block diagram of one computing environment in which embodiments of the present invention may be implemented.

FIG. 2 is a high-level schematic view of a parts-based user interface system.

FIG. 3 a flow chart illustrating steps associated with implementation of a parts-based user interface.

### DETAILED DESCRIPTION

### I. Exemplary Computing Environment

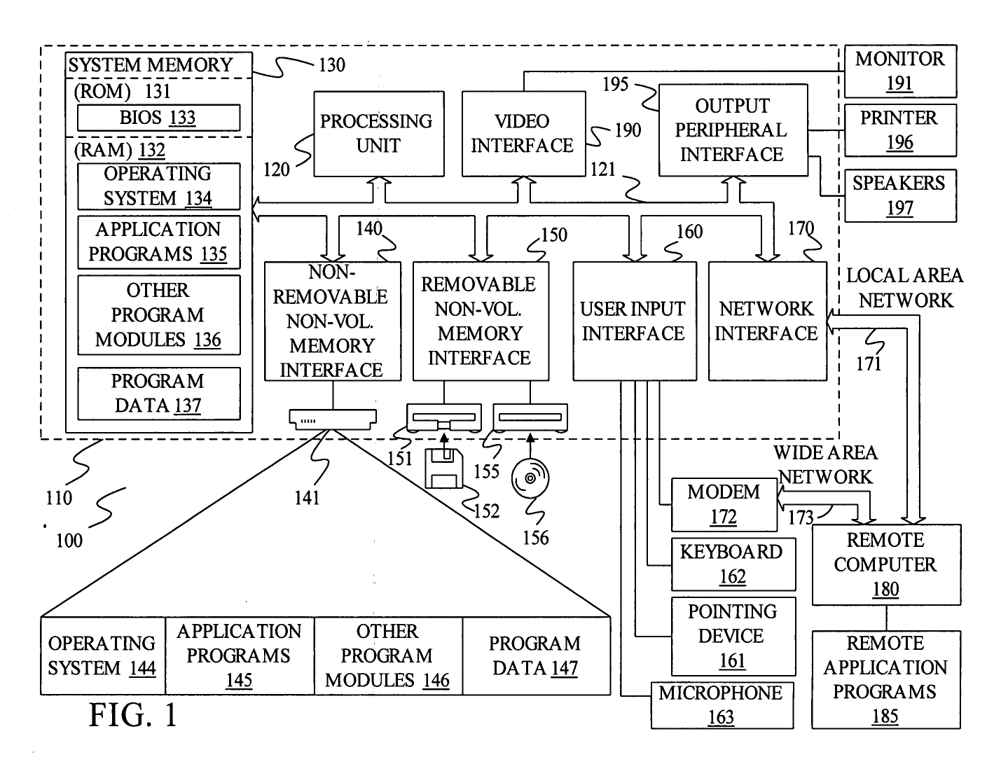

FIG. 1 illustrates an example of a suitable computing system environment 100 within which invention embodiments (described below in other sections) may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a central processing unit 120, a system memory 130, and a system bus 121 that couples various system components including the system memory to the processing unit 120.

The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

### II. Exemplary Applicable Software Environment

Development of a user interface often involves creation of numerous controls including many low-level controls such as, but certainly not limited to, text boxes, buttons and bits of text. It is common for various components of a given user interface to become so functionally intertwined that anyone, including the developer, can find it difficult to make changes, modifications or adjustments. These challenges make it difficult to support a user interface that allows a user to easily delete, swap or replace interface components for any purpose such as customization.

At least partially in response to the described need for a more flexible user interface, it is becoming increasingly common for products to incorporate a parts-based user interface. One example of a commercially available software product configured to support implementation of such an interface is Microsoft SharePoint Portal Server offered by Microsoft Corporation of Redmond, Wash.

Generally speaking, within a parts-based interface, large chunks of a display and associated functionality are componentized into individual “parts.” To some degree, the various parts each have a predetermined and explicit interface that regulates what data is sent out and what data is to be received in. This implementation of a standard interface enables multiple parts to be functionally linked together without being written to incorporate explicit knowledge of one another. Thus, for example, a given display can be customized by re-wiring functional relationships as necessary to support the deleting, adding or swapping of parts.

Generally speaking, a parts-based user interface system provides a powerful and easy to use platform for developing data driven user interface environments. The platform typically includes some level of built-in extensibility and support for code re-use. A user interface that is a product of such a system can typically be customized even at runtime by an end user. The resulting user interface is often capable of supporting shared and personal views. These are only several examples of many potential benefits in terms of flexibility.

A fundamental notion within many parts-based user interface systems is the concept of a page. A page is essentially a display that integrates a plurality of user interface parts. Each part is generally a customizable user interface component. A personalized user interface is created in many systems by simply dragging and dropping parts onto a page. Parts commonly support customization at both design time and at run time.

A variety of specific enabling data components may be associated with a part. Examples of applicable data components include a description file in the form of a portable container of default and personalized property values, an assembly file containing applicable logic and code, resource files that support the part, and tables used to store current values of part properties. While some embodiments described below in other sections pertain to a specialized exception to commonality, it is also typical for a standard part to also be associated with an element that is displayed as a visual representation of the part. In accordance with one embodiment, a part is implemented as an ASP .NET server control. In this case, to create a new part means to simply create an ASP .NET custom control.

### III. Overview of Faceless Parts

Within a parts-based user interface environment, there are times when a developer or user will desire to incorporate functionality that does not necessarily require a visibly exposed user interface component. For example, a visual representation may not be necessary for some functionality occurring on a processing level, such as synchronization functionality configured to hit a database and perform client-side operations. This is just one example. Other examples will be described below.

A specialized user interface component illustratively operates as a part but is not associated with any element that is visibly rendered for display (or is rendered in a way that is generally not visually perceptible). In one embodiment, the specialized user interface supports a parts-based communication interface so as to enable inter-operation with standard parts that are associated with a rendered element. This inter-operation between parts is illustratively conducted through the same standardized interfaces through which visibly exposed parts communicate with one another.

Thus, a “faceless part” is implemented so as to expose the same communication interfaces as a standard part but without being associated with an element that is visibly brought to a user's attention. For example, in accordance with one embodiment, no element is rendered for a faceless part. In another embodiment, an element is technically rendered but done so in a non-traditional manner that causes it to be visibly insignificant (i.e., rendered in a non-visible display area outside a user's field of view, or rendered so small as to be not or barely perceptible).

In some known user interface systems, certain foundational pieces and functions have been implemented as “hidden parts.” It is known for hidden parts do not include any element that is visibly rendered on a user display. However, hidden parts have not been implemented as primary interface components within a parts-based user interface, as are faceless parts. Communication with hidden parts is generally conducted through proprietary channels. For hidden parts, communication has traditionally been based on a hard binding of the hidden part to a regular part. Hard binding generally requires knowledge of what class structure looks like. Generally speaking, for hidden parts, programming must account for what is being communicated with, as well as how communication is to be handled.

In contrast, in the context of faceless parts, communication is conducted through generic, well-defined channels instead of through proprietary channels. The channels are generally generic. For example, when a Class A is configured to load up and call methods on a Class B, Class B can just as easily be replaced with a Class C with no negative effects at runtime. This provides a much greater flexibility than that offered by any hidden part.

The scope of the present invention is not limited to any particular function being implemented as a faceless part. A few examples will now be provided. A navigation context function is one example of a function that can be implemented as a faceless part. This function illustratively tracks locations to which a user has navigated. The tracking function conceivably will need to interact with a visible part but will not necessarily need to be visibly exposed. For example, when a user selects a ‘back’ button in the context of an Internet browser, some function needs to provide an element of navigation history in order to support an automatic jump backwards to the previous page. The underlying tracking function need not necessarily be visibly exposed.

Similarly, a user context function can be implemented as a faceless part to track current user information, to track which user is logged in, to track security credentials, and the like. It is conceivable for displayed parts to need this information but it may make little sense to visibly expose the underlying tracking functions. Thus, such functionality can be implemented as a faceless part.

A function associated with a task bar icon is another example of a function that can be implemented as a faceless part. While the actual task bar itself that contains the icon may be a visible user interface part, it is common for various functions to occur behind the icon (e.g., a file watching function). In one embodiment, an underlying function is implemented as a faceless part and is configured to inter-operate on some level with a visible part, such as the task bar.

A printer function is yet another example. When a user selects a print command, the expectation is that there is some print functionality that is going to cooperate with currently displayed parts to conduct an aggregation of information to be printed. That aggregation function can be implemented as a faceless part. This is an example of a faceless part that is command oriented instead of data oriented. In one embodiment, commands associated with a faceless part are routed through the same interface channels that any other communication between two parts would.

### IV. Implementation of Faceless Parts

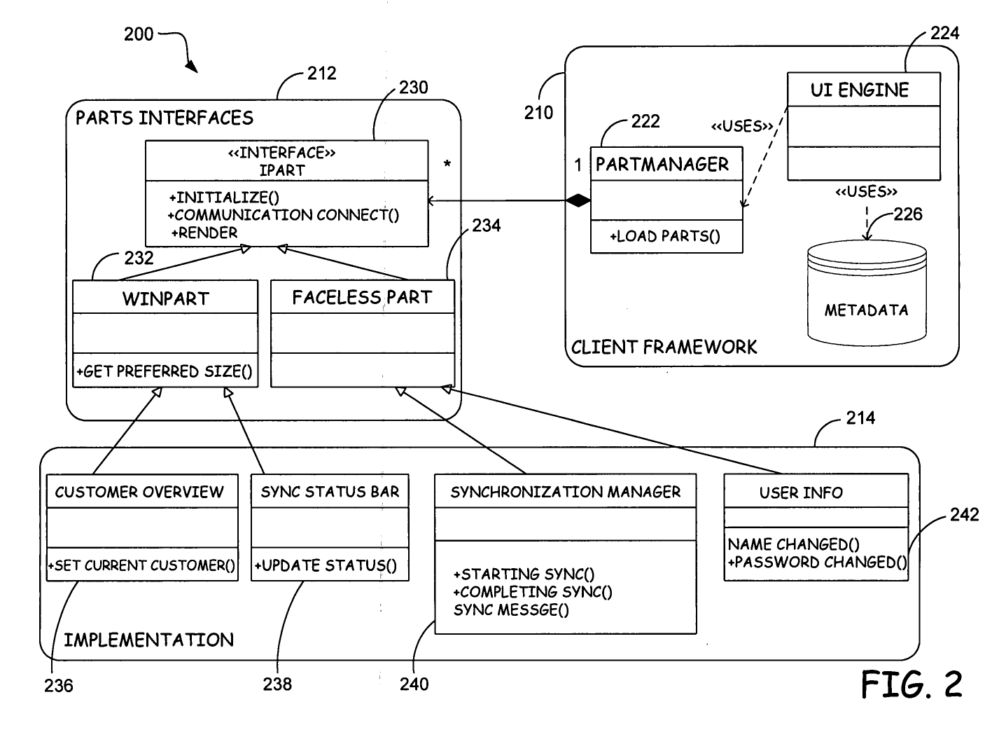

FIG. 2 is a high-level schematic view of an embodiment of a parts-based user interface system 200. System 200 includes a client framework 210, parts interfaces 212, and part implementations 214. Those skilled in the art will recognize that system 200 is, for the purpose of clarity, likely over-simplified as compared to an actual operational system.

Framework 210 includes a user interface engine 224 and a part manager 222 that are configured to read metadata 226, which generically points to classes that implement a plurality of part interfaces. For the purpose of simplifying the system of FIG. 2, only one part interface 212 is shown. As parts are loaded by part manager 222 during implementation of a user interface by user interface engine 224, their part-to-part communication channel is functionally established (i.e., “wired together”) through a callback mechanism. In accordance with one embodiment, in C++, a function pointer is utilized for this purpose. In accordance with another embodiment, in a .Net platform, .Net delegates are utilized. Those skilled in the art will appreciate that any other similar means can be utilized without departing from the scope of the present invention. Once the parts are wired together, they are then able to communicate with each other directly.

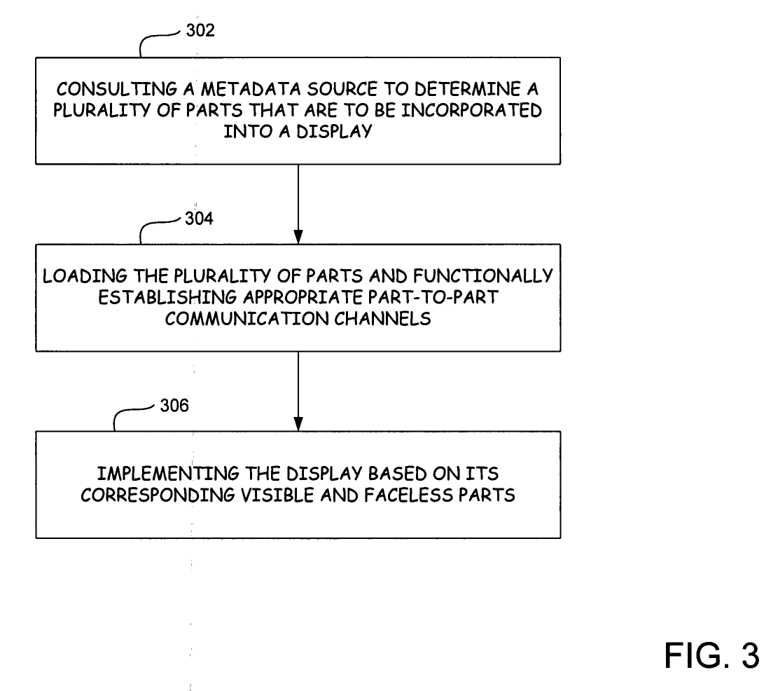

FIG. 3 is a flow chart illustrating steps associated with implementing an embodiment of a parts-based user interface. In accordance with step 302, a metadata source is consulted to determine a plurality of parts that are to be incorporated into a display. Step 304 comprises loading the plurality of parts and functionally establishing appropriate part-to-part communication channels. The communication channels can link visible parts to one another, faceless parts to one another and/or visible parts to faceless parts. In accordance with step 306, the final step comprises implementation of the display based on its corresponding visible and faceless parts.

The illustrated part interface 212 includes a primary part component 230 having a faceless part component 234 and a visible part component 232. Parts associated with component 232 are illustratively “traditional” or “visible” parts in that they include a user interface component that is to be rendered on a display for observation by a user. In contrast, parts associated with component 234 are illustratively “faceless” parts in that they are either not rendered at all or are rendered in a non-traditional way that makes them visually insignificant from a user's perspective. With reference to FIG. 2, visible parts 236 and 238 are associated with component 232, while faceless parts 240 and 242 are associated with component 234.

The way a visible part is loaded and tied to other visible parts is illustratively identical to how faceless parts are loaded and tied to each other and to the visible parts. In one embodiment, part manager 222 is configured to perceive parts simply as an implementation of primary part components 230. Regardless of the particular means of implementation, the system is, in one embodiment, configured such that a faceless part can be wired to other faceless parts or to visible parts, and visible parts can be tied to other visible parts or to faceless parts. As has been alluded to, these functional connections between parts, are illustratively implemented by part manager 222 and/or the user interface engine 224 through a leveraging of communication interfaces that are typical to a parts-based development platform.

Metadata 226 illustratively includes page metadata that is configured to serve as a reference tool and includes information that defines the appearance of a particular display (i.e., the screen appearance). For example, the page metadata establishes that a given display will include a certain number of visible parts. The parts scheme can illustratively be re-configured, which will initiate corresponding changes to metadata 226. Visible parts can be adjusted to show up in different spots. Also, visible parts can be added, deleted or replaced. As changes are made, corresponding adjustments are made to the page metadata. Visible parts are therefore exposed on a display though page metadata. In one embodiment, the page metadata is implemented as an XML file.

Illustratively, faceless parts are also implemented through the page metadata. When there is a desire to add functionality to a given page (e.g., a print function), a corresponding faceless part is added to that page. Information corresponding to the new faceless part is stored within the page metadata. The various parts, whether faceless or visible, are, at some point, wired together for communication though their parts-based interfaces.

The design time experience is illustratively similar for visible and faceless parts. In one embodiment, because faceless parts by definition do not have a visually significant user interface component, during design mode a generic representation is provided for the benefit of the developer. In one embodiment, faceless parts reside in a “gutter” during design mode and fall off screen (or become visually insignificant) during normal operation. Thus, in one example of a design mode environment, eight parts, including three faceless parts, are visually represented to enable a developer to support the establishment of functional associations (i.e., wiring the parts together through the parts-based interfaces). During, the normal running of the application, however, only the five visible parts will be rendered in a way that is visually significant from the user's perspective.

Within a parts-based design environment, a part is defined and illustratively includes information that supports communication with other parts. Whether this new part includes a visually significant user interface component, as far as other parts are concerned, is generally not important. Thus, the design experience is simplified in terms of facilitating interaction among different parts, and in terms of having applicable architecture as well. In one embodiment, the development experience associated with visible and faceless parts is generally identical, except faceless parts will not required configuration of a user interface on the surface.

Thus, embodiments pertain to a base class or interface that supports implementation of faceless parts. The base class or interface is the basis for the derivation of parts in the parts-based user interface. The base class or interface represents a first-class citizen in the parts-based interface framework. The base class or interface illustratively exposes the same inter-part communication capabilities as any other part. That being said, there are some differences between this base and the base from which other parts derive. For example, in one embodiment, the base cannot derive from any other base that exposes a user interface, as faceless parts will not expose a user interface. However, faceless parts will still expose the same communication, events and methods as are exposed by visible parts.

Thus, in one example, a page or screen includes four or five different parts. Those parts are illustratively functionally wired together for interaction through standard interfaces associated with the parts-based user interface framework. In accordance with one aspect of the present invention, at least one of the parts is a faceless part that does not appear in a visually significant way on the page or screen but is still wired for interaction with at least one of the other parts.

Faceless parts are illustratively activated (i.e., their functions are initiated) in a variety of different ways. In one embodiment, a faceless part is activated when another faceless or visible part sends a message to it though a well-defined message channel associated with the parts-based communication interface. In another embodiment, a faceless part is configured to watch a message bus, a file on a hard disc, etc., and activation occurs when a particular change occurs. Those skilled in the art will appreciate that all other activation means are to be considered within the scope of the present invention.

Although the present invention has been described with reference to particular embodiments, workers skilled in the art will recognize that changes may Abe made in form and detail without departing from the spirit and scope of the invention.

What is claimed is:

1. A computer-implemented method for supporting a parts-based user interface, the method comprising:
functionally establishing a part-to-part communication channel between a faceless part and a visible part by way of a standard communication interface through which the visible part is configured to communicate with other visible parts.

2. The method of claim 1, further comprising receiving a request to load a display; and
consulting a data source to determine the visible part and the faceless part, which are components to be incorporated into the display.

3. The method of claim 1, wherein the faceless part is a part that is not associated with an element to be rendered.

4. The method of claim 1, wherein the faceless part is configured to provide data to the visible part.

5. The method of claim 1, wherein the faceless part is configured to receive data from the visible part.

6. The method of claim 1, wherein the faceless part is a part that is associated with an element configured to be rendered in a visually insignificant manner.

7. The method of claim 1, wherein the faceless part is associated with an element configured to be rendered so minimally that a user is not able to visually identify the element without being apprised of its location within a display.

8. The method of claim 1, wherein the faceless part is associated with an element configured to be rendered so as to not appear within a display.

9. A faceless part configured to operate as a component within a parts-based user interface, wherein the faceless part is not associated with an element to be rendered as part of a display but is configured to participate in inter-part communication though a standard communication infrastructure used by visible parts within the parts-based user interface.

10. The faceless part of claim 9, wherein the standard communication infrastructure comprises a communication interface through which visible parts are configured to communicate with one another.

11. The faceless part of claim 9, wherein the standard communication infrastructure comprises a modular communication interface that does not limit communication to any particular part or parts.

12. The faceless part of claim 9, wherein the standard communication infrastructure comprises a communication interface that enables one part to communicate with any of a variety of other interchangeable parts.

13. A parts-based user interface system, comprising:
a visible part that includes a parts-based communication interface, the visible part also being associated with an element that is to be visibly rendered within a display,
a faceless part that is configured to communicate with the visible part through the parts-based communication interface, wherein the faceless part is not associated with an element that is to be visibly rendered within a display.

14. The system of claim 13, wherein the parts-based communication interface is the same interface through which the visible part is configured to communicate with other visible parts.

15. The system of claim 13, wherein the faceless part is configured to provide data to the visible part.

16. The system of claim 13, wherein the faceless part is configured to receive data from the visible part.

17. The system of claim 13, wherein the faceless part is associated with an element that is to be rendered so as to not appear within a display.

18. The system of claim 13, wherein the faceless part is associated with an element that is to be rendered outside of a visible portion of a display.

19. The system of claim 13, wherein the parts-based communication interface is a modular communication interface that does not limit communication to any particular part or parts.

20. The system of claim 13, wherein the parts-based communication interface is configured to enable one part to communicate with any of a variety of other parts.
